(19) United States
(12) Patent Application Publication
(10) Pub. No.: US 2016/0065853 A1
(43) Pub. Date: Mar. 3, 2016

(54) APPARATUS FOR DRIVING AUTO FOCUSING AND CONTROLLING METHOD THEREOF

(71) Applicant: SAMSUNG ELECTRO-MECHANICS CO., LTD., Suwon-Si (KR)

(72) Inventors: Myung Gu KANG, Suwon-si (KR); Peter Jean Woo LIM, Suwon-Si (KR)

(73) Assignee: SAMSUNG ELECTRO-MECHANICS CO., LTD, Suwon-Si (KR)

(21) Appl. No.: 14/818,462

(22) Filed: Aug. 5, 2015

(30) Foreign Application Priority Data
Aug. 29, 2014 (KR) 10-2014-0113775

(51) Int. Cl. H04N 5/232

(52) U.S. Cl. CPC H04N 5/23258; H04N 5/23212; H04N 5/23254

(57) ABSTRACT

There is provided an apparatus for driving auto focusing including: a motion sensor outputting motion data on motion of a camera module; a processor generating a control signal for controlling a focus of a subject based on the motion data; and an optical driving module moving a lens in a predetermined direction based on the control signal.

### CROSS-REFERENCE TO RELATED APPLICATION

This application claims the benefit of Korean Patent Application No. 10-2014-0113775, filed on Aug. 29, 2014, entitled “Apparatus for Driving Auto Focusing and Controlling Method Thereof” which is hereby incorporated by reference in its entirety into this application.

### BACKGROUND

The present disclosure relates to an apparatus for driving auto focusing and a controlling method thereof.

A photographing device such as a digital camera, a camcorder, a camera phone, or the like, includes a lens and an image sensor in which an image of a subject transmitted through the lens is photographed and adjusts a distance between the lens and the image sensor by changing a position of the lens.

Therefore, auto focusing (AF) is a function of adjusting a focus of the image of the subject photographed in the image sensor, changing the position of the lens to calculate a focusing degree of the image of the subject at each position, and automatically adjusting the position of the lens so as to have an optimal focus.

In addition, as an auto focusing method, first, there is a contrast detection method of measuring a contrast of a specific portion of the image using the image sensor while continuously moving the lens, and determining that the lens is focused when the contrast becomes maximum.

In addition, as the auto focusing method, second, there is a phase-difference detection method of determining a driving direction and a driving amount of the lens based on phase-difference data generated at the time of separating incident light into two parts to thereby be incident on two different sensors, respectively.

### RELATED ART DOCUMENT

### Patent Document

(Patent Document 1) KR 2009-0104769

### SUMMARY

An aspect of the present disclosure may provide an apparatus for driving auto focusing capable of detecting a driving direction and a movement amount of a lens based on output data of a motion sensor corresponding to motion of a subject, in order to solve problems caused by performing an auto focusing method according to the related art.

In an apparatus for driving auto focusing and a controlling method thereof according to exemplary embodiments of the present disclosure, an accurate movement amount and movement direction of a lens may be detected using acceleration data corresponding to motion of a camera module, such that an accurate and rapid auto focusing operation may be performed as compared to an auto focusing method according to the related art.

According to an aspect of the present disclosure, an apparatus for driving auto focusing may include: a motion sensor outputting motion data on motion of a camera module; a processor generating a control signal for controlling a focus of a subject based on the motion data; and an optical driving module moving a lens in a predetermined direction based on the control signal.

Further, the processor may calculate a phase-difference variable C between images formed on an image sensor depending on motion of the camera module based on acceleration data from which static acceleration data are removed, and detect a defocus amount (movement amount) of the lens corresponding to the phase-difference variable C.

In addition, the processor may generate a control signal corresponding to the defocus amount and movement direction of the lens to transmit the control signal to an optical driver. The optical driver may generate a driving current depending on the control signal to apply the driving current to an actuator, and the actuator may move the lens in an optical axis direction depending on the driving current to re-set a focus of the subject depending on motion of the camera module.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of an apparatus for driving auto focusing according to an exemplary embodiment of the present disclosure;

FIG. 2A is a diagram illustrating a state in which a focus of a subject is adjusted for a lens, and FIG. 2B is a diagram illustrating a state in which the focus of the subject is moved depending on motion of the subject;

FIG. 3 is a diagram schematically illustrating an auto focusing method according to an exemplary embodiment of the present disclosure; and

FIG. 4 is a flow chart illustrating a controlling method of an apparatus for driving auto focusing according to an exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

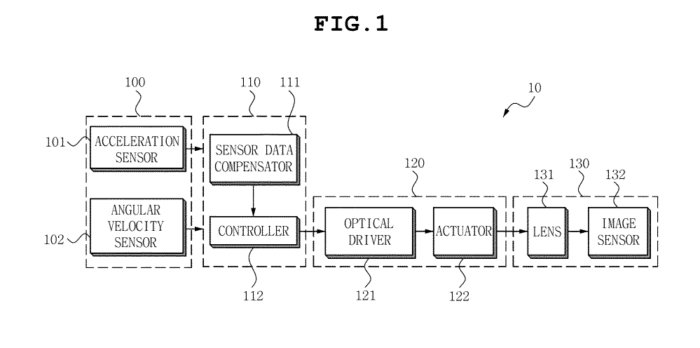

FIG. 1 is a block diagram of an apparatus for driving auto focusing according to an exemplary embodiment of the present disclosure. The apparatus for driving auto focusing according to an exemplary embodiment of the present disclosure includes a motion sensor sensing a velocity change of motion of a subject, or the like, a processor generating a control signal for controlling a focus of the subject based on output data of the motion sensor, and an optical driving module driving the lens based on the control signal.

The motion sensor 100 may be provided the inside or outside a camera module 130, sense a velocity change for motion of the camera module 130, and output data on the velocity change.

That is, the motion sensor 100 may include an angular velocity sensor 102 sensing a rotational component (angle) change of the camera module 130 and an acceleration sensor 101 sensing a linear component (velocity) change by motion of the camera module 130 in a vertical or horizontal direction.

Here, 1) the angular velocity sensor 102 may be a gyro sensor capable of sensing angle changes in x-axis, y-axis, and z axis directions in order to compensate vertical and horizontal hand vibration of the camera module 130 caused by hand vibration of a user, and 2) the acceleration sensor 101 may sense the velocity changes of the camera module 130 by the user in the x-axis, y-axis, and z axis directions, wherein the velocity changes correspond to the linear component for motion of the camera module 130.

A lens 131 may form an image of light flux from the subject on an image sensor 132 and include a zoom lens, a focus lens, or a compensation lens. In addition, the image sensor 132 may be a charge coupled device (CCD) or complementary metal-oxide-semiconductor (CMOS) optically treating light from the subject to detect an image of the subject and converting an optical signal of incident light into an electrical analog signal.

The processor 110 generates the control signal for controlling the focus of the subject based on the output data of the motion sensor 100 to transmit the control signal to the optical driving module 120. Here, the processor 110 includes a sensor data compensator 111 and a controller 112.

In addition, the processor 110 removes static acceleration data included in output data of the acceleration sensor 101 using output data of the angular velocity sensor 102 depending on motion of the camera module 130.

Further, the processor 110 calculates a phase-difference variable C between images formed on the image sensor 132 depending on the motion of the subject based on the output data of the acceleration sensor from which the static acceleration data are removed, and detects a defocus amount (movement amount) of the lens corresponding to the phase-difference variable C.

The sensor data compensator 111 removes the static acceleration data included in the output data of the acceleration sensor 101 using the output data of the angular velocity sensor 102 depending on motion of the camera module 130.

That is, the acceleration data output from the acceleration sensor 101 includes the static acceleration data and dynamic acceleration data. The static acceleration data are data on rotation for a small tilt of the camera module 130, or the like, gravity acceleration, or the like, and in the case in which the static acceleration data are not compensated (removed), wrong focusing may be performed during an auto focusing process for motion of the camera module 130.

Therefore, the sensor data compensator 111 calculates the rotational component of the camera module 130 from angular velocity data depending on motion of the camera module 130 and performs a compensation step of removing the static acceleration data from the acceleration data using the rotational component.

In addition, the controller 112 calculates the phase-difference variable C between images of the subject formed on the image sensor depending on motion of the subject based on the output data of the sensor data compensator 111 and generates a control signal for the defocus amount (movement amount) of the lens 131 corresponding to the phase-difference variable C and a movement direction of the lens 131.

The optical driving module 120 includes an actuator 122 moving the lens 131 in an optical axis direction and an optical driver 121 applying a driving current depending on the control signal transmitted from the processor 110 to the actuator 122.

The optical driver 121 generates a driving voltage of the actuator 122 for moving the lens 131 depending on the control signal input from the processor 110 and a control signal (driving current).

Further, the optical driver 121 controls the driving of the actuator 122 through a switching operation corresponding to the control signal to control a moving range of the lens 131. Here, the optical driver 121 may be embedded in the processor 110 as a motor driver IC, and the actuator 122 includes a voice coil motor (VCM) or piezoelectric device.

The processor 110, the sensor data compensator 111, and the controller 112 as described above may include algorisms for performing the above-mentioned functions and be implemented by firmware, software, or hardware (for example, a semiconductor chip or application-specific integrated circuit).

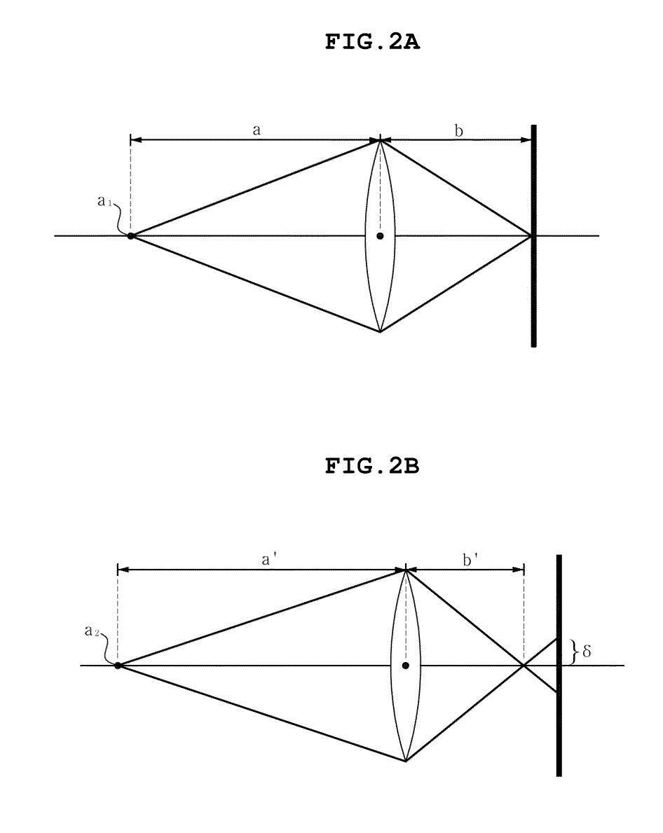

Hereinafter, the apparatus for driving auto focusing and a controlling method thereof according to the present disclosure will be described with reference to FIGS. 2 to 4.

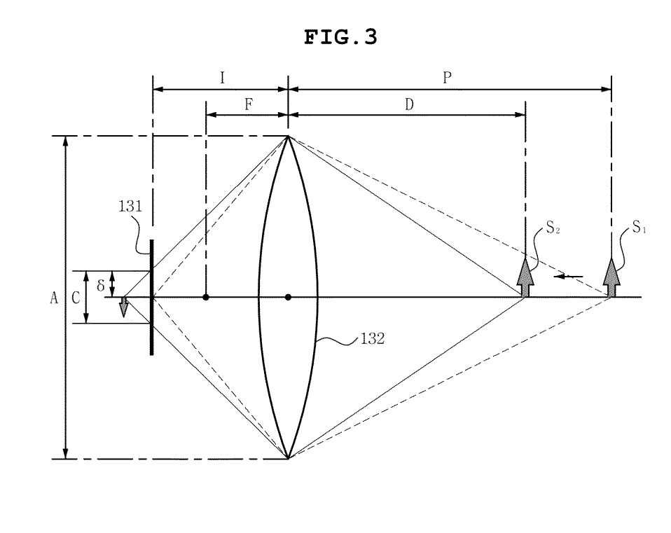

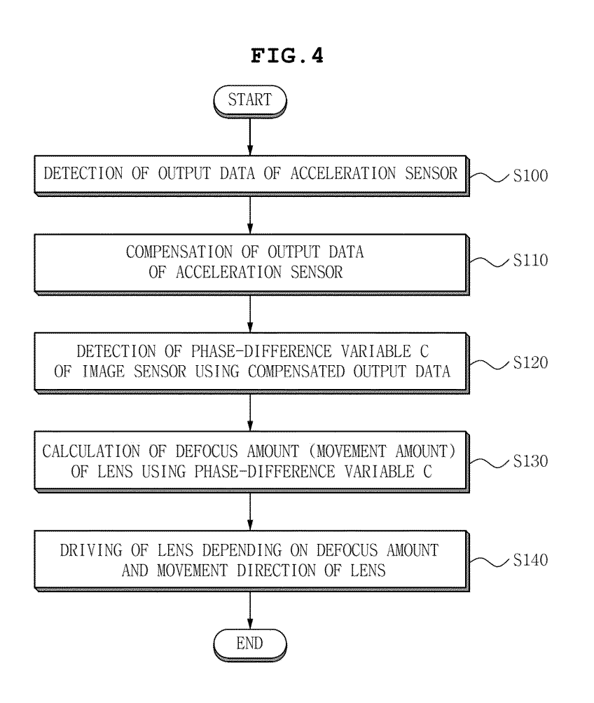

FIG. 2A is a diagram illustrating a state in which a focus of the subject is adjusted for the lens, and FIG. 2B is a diagram illustrating a state in which the focus of the subject is moved depending on motion of the subject. FIG. 3 is a diagram schematically illustrating an auto focusing method according to an exemplary embodiment of the present disclosure, and FIG. 4 is a flow chart illustrating a controlling method of an apparatus for driving auto focusing according to an exemplary embodiment of the present disclosure.

As illustrated in FIG. 2A, when light passing through the lens 131 is concentrated on an image photograping surface of the image sensor 132 while being collected on one point, the image of the subject becomes vivid. In this case, the subject is in a state in which the focus thereof is adjusted for the lens 131.

For example, based on one point a1 configuring the subject, an interval between one point a1 and the lens is a, and the light incident from the one point a1 on the lens 131 is concentrated on the image photograping surface of the image sensor 132 spaced apart from the lens 131 by b.

However, as illustrated in FIG. 2b, in the case in which one point a1 of the subject is moved to another point a2 depending on motion of the camera module 130, the interval between one point a1 and the lens 131 is changed (a→a′), such that a point on which light incident from another point a2 transmits through the lens 131 to thereby be collected is changed from b into b′.

That is, as the subject becomes close to the lens 131, a focal length for the subject is increased. In this case, the lens 131 moves toward the subject in order to adjust the focus of the subject to thereby become far away from the image photograping surface of the image sensor 132.

In this case, a circle of confusion formed by scattering of the light incident from another point a2 is formed on the image photograping surface of the image sensor 132, and a size δ of the circle of confusion is determined depending on an interval between the subject and the lens 131. Here, δ means a phase-difference between images (interval between two images) formed on the image photograping surface of the image sensor 132 in a state in which the focus of the subject is adjusted and in a state in which the focus of the subject is not adjusted.

Therefore, as illustrated in FIG. 3, in the apparatus 10 for driving auto focusing according to the exemplary embodiment of the present disclosure, in the case in which the subject is positioned at a S1 position, light incident from one point of the subject transmits through the lens 131 to thereby be concentrated on the image photograping surface of the image sensor 132. That is, the image of the subject is in a state in which a focus thereof is adjusted for the lens 131.

In this case, the processor 110 calculates a distance P between the subject and the lens 131 using a distance I between the lens 131 and the image sensor 132 and a natural focal distance F of the lens 131. Here, I and F are preset values due to characteristics of the camera module 130.

In addition, when the position of the subject is changed into S2 depending on motion of the camera module 130 by the user, the acceleration sensor 101 outputs acceleration data on the velocity change in a linear direction and angular velocity data on rotation, corresponding to motion of the camera module 130 (S100).

Then, the sensor data compensator 111 removes (compensates) the static acceleration data included in the acceleration data using the angular velocity data (S110) to transmit the acceleration data from which the static acceleration data are removed to the controller 112.

In addition, the controller 112 calculates a phase-difference variable C between images of the subject formed on the image sensor 132 corresponding to motion of the camera module 130 using the acceleration data from which the static acceleration data are removed (S120).

That is, the controller 112 calculates the phase-difference variable C according to the following [Equation 1] and [Equation 2] using the acceleration data transmitted from the sensor data compensator 111.

$$\begin{matrix}\frac{1}{P} + \frac{1}{I} = \frac{1}{F} & [ Equation 1 ] \\ C = \vert A \frac{F ( P - D )}{D ( P - F )} \vert & [ Equation 2 ]\end{matrix}$$

Here, P indicates the distance between the lens 131 and the subject, and I indicates the distance between the lens 131 and the image sensor 132. F indicates the natural focal distance of the lens 131, D indicates a distance between a point at which the subject is moved and the lens 131, and A indicates a diameter of the lens.

In more detail, the controller 112 detects a movement direction of the camera module 130 from the acceleration data transmitted from the sensor data compensator 111. That is, the reason is that the acceleration data are vector values having a magnitude and a direction.

In addition, a movement distance of the camera module 130 may be calculated through integration of the acceleration data, such that a change (P-D) in the distance between the subject and the camera module 130.

Further, the controller 112 calculates the phase-difference variable C according to [Equation 1] and [Equation 2] using the distance I between the lens 131 and the image sensor 132 detected in advance in a state in which the focus of the subject is adjusted before the camera module 130 moves, the distance P between the lens 131 and the subject, and the diameter A of the lens 131, which is a natural property of the lens 131.

Thereafter, the controller 112 calculates a defocus amount (movement amount) of the lens required in order to adjust the focus of the subject changed depending on the motion of the camera module 130 using the phase-difference variable C (S130) and generates a control signal for moving the lens 131 depending on the defocus amount.

Here, the phase-difference variable C is 2δ, and the defocus amount of the lens 131 depending on the phase-difference δ, which is a pre-calculated value at the time of designing the lens 131, may be stored in a memory (not illustrated), or the like.

In addition, the controller 112 transmits the control signal to the optical driver 121 and the optical driver 121 generates a driving current corresponding to the control signal to apply the driving current to the actuator 122.

Therefore, the actuator 122 moves the lens 131 depending on the defocus amount and the movement direction corresponding to the control signal to re-adjust the focus of the subject (S140).

As described above, in the apparatus for driving auto focusing and the controlling method thereof according to the present disclosure, the accurate movement amount and movement direction of the lens may be detected using the acceleration data corresponding to motion of the camera module, such that an accurate and rapid auto focusing operation may be performed as compared to an auto focusing method according to the related art.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An apparatus for driving auto focusing comprising:
a motion sensor outputting motion data on motion of a camera module;
a processor generating a control signal for controlling a focus of a subject based on the motion data; and
an optical driving module moving a lens in a predetermined direction based on the control signal.

2. The apparatus for driving auto focusing of claim 1, wherein the motion sensor includes:
an angular velocity sensor outputting angular velocity data indicating a rotational component (angular velocity) change of the camera module; and
an acceleration sensor outputting acceleration data indicating a linear component (acceleration) change of the camera module.

3. The apparatus for driving auto focusing of claim 1, wherein the optical driving module includes:
an actuator moving the lens in an optical axis direction; and
an optical driver applying a driving current depending on the control signal transmitted from the processor to the actuator.

4. The apparatus for driving auto focusing of claim 2, wherein the processor removes static acceleration data included in the acceleration data using the angular velocity data depending on motion of the camera module.

5. The apparatus for driving auto focusing of claim 4, wherein the processor generates a control signal corresponding to a defocus amount (movement amount) and a movement direction of the lens based on the acceleration data from which the static acceleration data are removed.

6. The apparatus for driving auto focusing of claim 5, wherein the processor calculates a phase-difference variable C between images formed on an image sensor depending on motion of the camera module based on the acceleration data from which the static acceleration data are removed, and detects the defocus amount (movement amount) of the lens corresponding to the phase-difference variable C.

7. The apparatus for driving auto focusing of claim 2, wherein the processor includes:
a sensor data compensator removing static acceleration data included in the acceleration data using the angular velocity data depending on motion of the camera module; and
a controller calculating a phase-difference variable C between images of the subject formed on an image sensor depending on motion of the subject based on output data of the sensor data compensator and generating a control signal for a defocus amount (movement amount) of the lens corresponding to the phase-difference variable C and a movement direction of the lens.

8. The apparatus for driving auto focusing of claim 3, wherein the actuator is a voice coil motor.

9. A controlling method of an apparatus for driving auto focusing, the controlling method comprising:
outputting, by a motion sensor, motion data on motion of a camera module;
generating, by a processor, a control signal for controlling a focus of a subject based on the motion data; and
driving, by an optical driving module, a lens so as to be moved in a predetermined direction based on the control signal.

10. The controlling method of claim 9, wherein the outputting of the motion data includes:
sensing, by an acceleration sensor, a velocity change of the camera module in a linear direction to output acceleration data on the velocity change; and
sensing, by an angular velocity sensor, an angular velocity change for rotation of the subject to output angular velocity data on the angular velocity change

11. The controlling method of claim 10, wherein the generating of the control signal includes:
removing, by a sensor data compensator, static acceleration data included in the acceleration data using the angular velocity data depending on motion of the camera module;
calculating, by a controller, a phase-difference variable C between images of the subject formed on an image sensor depending on motion of the camera module based on output data of the sensor data compensator; and
generating, by the controller, a control signal for a defocus amount (movement amount) of the lens corresponding to the phase-difference variable C and a movement direction of the lens.

12. The controlling method of claim 11, wherein the driving of the lens includes:
applying, by an optical driver, a driving current depending on the control signal transmitted from the controller to an actuator; and
moving, by the actuator, the lens in an optical axis direction depending on the driving current.
